(19) United States
(12) Patent Application Publication
(10) Pub. No.: US 2020/0258023 A1
(43) Pub. Date: Aug. 13, 2020

(54) SYSTEMS AND METHODS FOR ACCURATE IMAGE CHARACTERISTIC DETECTION

(71) Applicant: ShopperTrak RCT Corporation, Chicago, IL (US)

(72) Inventors: Michael Paolella, Lake Zurich, IL (US); David M. Berg, II, Chicago, IL (US)

(21) Appl. No.: 16/274,561

(22) Filed: Feb. 13, 2019

(51) Int. Cl. G06Q 10/06; G06K 9/00

(52) U.S. Cl. CPC G06Q 10/06393; G06Q 10/06398; G06K 9/00369; G06K 9/00342; G06K 9/00315

(57) ABSTRACT

Systems and methods for improving accuracy of detecting characteristics of an image in an image detection system. The methods comprise: capturing, by a camera, at least one image or video showing one or more customers in a facility; performing image or video analysis to identify words that define emotions of the one or more customers shown in the at least one image or video; translating the identified words to numerical values in accordance with a pre-defined symbol coding scheme; and combining the numerical values to derive a customer sentiment value for the one or more customers in the at least one image or video.

### BACKGROUND

### Statement of the Technical Field

The present disclosure relates generally to employee management systems. More particularly, the present disclosure relates to implementing systems and methods for measuring and improving employee performance.

### Description of the Related Art

An objective methodology for measuring employee performance and how that performance impacts customer sentiment is valuable for managing employees individually and at scale. Current approaches focus on staff to customer ratios, Point of Sale (“PoS”) conversion and transaction rates, customer surveys and management assessments. Each one of these approaches is inherently flawed. Staff to customer ratios do not account for the performance of individual employees. PoS conversion and transaction rates do not give any insight into customer experiences. Customer surveys, even when combined with loyalty programs, have low sample rates. Management assessments are subjective and often inconsistent.

### SUMMARY

The present disclosure concerns implementing systems and methods for measuring and improving employee performance. The methods comprise: capturing, by a camera, at least one image or video showing one or more customers in a facility; using, by a computing device, the at least one image or video to determine a customer sentiment value and a queue length value for at least one check-out line of the facility; obtaining, by the computing device, a basket value and a transaction duration for a completed purchase transaction associated with the one or more customers; determining, by the computing device, an Employee Productivity Score (“EPS”) using the customer sentiment value, the queue length value, the basket value, and the transaction duration; and using, by a computing device, the EPS to facilitate improved employee performance.

In some scenarios, the customer sentiment value is determined by: performing image or video analysis to identify words that define emotions of the one or more customers shown in the at least one image or video; translating the identified words to numerical values in accordance with a pre-defined symbol coding scheme; and combining the numerical values to derive the customer sentiment value. The words are identified by comparing facial expressions and movement patterns shown in the at least one image or video to reference facial expressions and movement patterns. The reference facial expressions and movement patterns may be derived based on machine learned facial expressions and movement patterns of the one or more customers.

In those or other scenarios, the methods further comprise improving an accuracy of the customer sentiment value and/or modifying the queue length value. The accuracy of the customer sentiment value improves based on social media information, machine learned customer information, survey results, customer inputs, and/or employee inputs. The queue length value is modified (a) using a scaling factor selected based on a time of day or time of year, and/or (b) to exclude customers of one or more types.

In those or other scenarios, the improved employee performance is facilitated by making at least one recommendation for at least one of an employee shift schedule change, an employee task re-assignment, and/or employee training. The recommendation may be selected to optimize at least one of the employee shift schedules and the on-shift employee floor plan. In this regard, the methods can further comprise: receiving a user-software interaction accepting the at least one recommendation; generating at least one optimized employee shift schedule or at least one optimized on-shift employee floor plan in response to the user-software interaction; and notifying employees of shift changes or task re-assignments in accordance with the at least one optimized employee shift schedule or at least one optimized on-shift employee floor plan.

### BRIEF DESCRIPTION OF THE DRAWINGS

The present solution will be described with reference to the following drawing figures, in which like numerals represent like items throughout the figures.

FIG. 1 is an illustration of an illustrative architecture for a system.

FIG. 2 is an illustration of an illustrative employee shift schedule.

FIG. 3 is an illustration of an illustrative optimized employee shift schedule.

FIG. 4 is an illustration of an illustrative employee floor plan.

FIG. 5 is an illustration of an illustrative architecture for a computing device.

FIGS. 6A-6B (collectively referred to as “FIG. 6”) provide a flow diagram of an illustrative method for measuring and improving employee performance.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present solution generally concerns systems and methods for measuring and improving employee performance. The present solution provides an ability to measure the performance of an employee including his(her) immediate impact on customer sentiment. This ability creates opportunity for retailers to optimize labor shift scheduling, optimize employee task assignments, and increase customer satisfaction. This then allows for lower labor costs, and creates the potential for larger basket sizes, increased customer loyalty and more effective employee development.

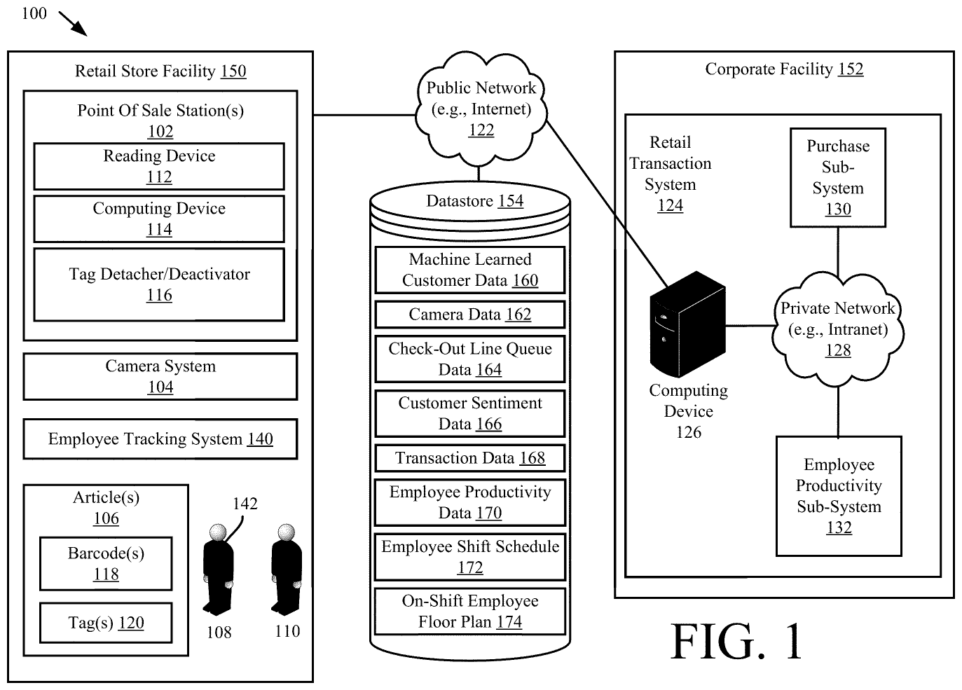

Referring now to FIG. 1, there is provided a schematic illustration of an illustrative system 100. The present solution is not limited to the architecture shown in FIG. 1. In this regard, it should be understood that system 100 can include more or less components than that shown in FIG. 1.

System 100 is generally configured to facilitate the purchase of articles 106 by customers 108, the measurement of employee performance, a determination as to how employee performance impacts customer sentiment, and/or an optimization of an employee shift schedule and/or an on-shift employee floor plan based on how the customer sentiment is being impacted by employee performance. The articles are also referred to herein as items and/or products. The articles include perishable items (e.g., food) and/or non-perishable items (e.g., apparel, appliances, automotive parts, beauty supplies, personal care items, books, consumer electronics, entertainment tickets, fashion accessories, footwear, office supplies, sports equipment, toys, video games, watches, glasses and/or jewelry).

System 100 comprises a Retail Store Facility (“RSF”) 150 including a POS station 102. POS stations are well known in the art, and therefore will not be described in detail herein. Any known or to be known POS station can be used herein without limitation. The POS station includes a fixed POS station (e.g., a traditional checkout counter), a self-checkout kiosk, or a mobile POS (e.g., a smart phone). The POS station(s) is(are) generally configured to facilitate the initiation of a purchase transaction and the completion of the same.

In some scenarios, a conventional POS station is modified to implement machine learning algorithms. Machine learning algorithms are well known in the art, and therefore will not be described herein. Any known or to be known machine learning algorithm can be used herein without limitation. Supervised machine learning algorithm(s), unsupervised machine learning algorithm(s) and/or semi-supervised machine learning algorithm(s) are employed by POS station 102. In this regard, hardware and/or software is provided with a POS station and/or a remote computing device 126 that is/are configured to learn facial features/characteristics of customers 110, learn patterns of movement/actions of the customers 110, and/or learn emotions of customers 110 based on the learned facial features/characteristics and/or patterns of movement/actions. The learned customer related information is stored in a datastore 154 as machine learning customer data 160, and may be used later for determining customer sentiment. Datastore 154 can include, but is not limited to, a database. This machine learning feature of the present solution accounts for different manners in which people express emotions (such as happiness, surprise, neutral, sadness, fear, disgust, and/or anger). Alternatively or additionally, pre-defined patterns of customer movement and/or pre-defined facial expressions associated with different emotions can be employed herein.

A camera system 104 is provided to assist with the machine learning. The camera system 104 includes one or more cameras located above, adjacent to, and/or in proximity to the POS station 102 (e.g., mounted on a wall or in a ceiling near the POS station). The cameras include, but are not limited to, digital cameras, camcorders, Internet Protocol (“IP”) cameras, thermal cameras, and/or PTZ cameras. The camera(s) capture(s) images and/or video(s) continuously, periodically at pre-defined times (e.g., every second(s), minute(s), etc.), and/or in response to trigger events (e.g., the detection of a customer in a check-out line). The images and/or videos are stored in the datastore 154 as camera data 162, and used later for determining check-out line queue lengths and/or customer sentiment. The check-out line queue lengths and/or customer sentiment are used to determine an EPS as described below. The EPS is stored in the datastore 154 as employee productivity data 170.

A check-out line queue length is the number of customers in a particular check-out line at a given time or during a given period of time. This number is stored in the datastore 154 as check-out line queue data 164. In some scenarios, a scaling factor is applied to the number for adjusting the queue length based on the time of day and/or the time of year. This scaling factor is selected to account for cases where two or more people are shopping together and are associated with a single purchase transaction. For example, two or more family members tend to shop more together during the holidays than other times of the year, and are collectively associated with the same purchase transactions. This fact should be accounted for when determining the employee's EPS associated with a particular purchase transaction. One way to do this is to apply a scaling factor to the check-out line queue length during the holidays (e.g., the check-out line queue length is divided by a number selected based on an estimated number of customers shopping together during the holidays or a machine-learned average number of customers shopping together during the holidays). The present solution is not limited in this regard.

The check-out line queue length may additionally or alternatively be reduced to exclude customers who are children or of a different type or characteristic. This queue length adjustment ensures that a given employee's EPS is not affected by customer actions which may impact the sentiment of other customers. For example, a first person is waiting in a check-out line along with two children. A second person is waiting in the check-out line behind the same. The children are misbehaving, and causing the second person to have an unpleasant experience. The second person's dissatisfaction is not at all impacted by an employee's conduct, but exclusively by the misbehaving children. As such, this fact should be accounted for when determining the employee's EPS. One way to do that is to decrement the check-out line queue length by the number of children in the particular check-out line at a given time or during a given period of time. The present solution is not limited in this regard.

The customer sentiment is an overall attitude of customers at a given time or during a given period of time. Customer sentiment is determined based on a feeling from customer facial features/characteristics and/or movement/actions. Techniques for determining customer sentiment are well known in the art, and therefore will not be described herein. Any known or to be known technique for determining customer sentiment can be used herein without limitation. Some techniques involve: performing image or video analysis to identify words that define emotions of the customers; translating the identified words to numerical values in accordance with a pre-defined symbol coding scheme; and combining the numerical values to derive the customer sentiment value. The words are identified by comparing facial expressions and movement patterns shown in the at least one image or video to reference facial expressions and movement patterns. Each reference facial expression and movement pattern has a word associated therewith. A word is identified as the word that corresponds to the reference facial expression and/or movement pattern that matches the captured facial expression and/or movement pattern by a certain amount (e.g., greater than 75%). The reference facial expressions and movement patterns include pre-defined universal facial expressions and movement patterns. This may not be desirable in some cases. As such, the machine learned facial expressions and movement patterns of actual customers mentioned above may be used to determine the words indicating customer emotions in addition to or as an alternative to the universal facial expressions and movement patterns for people.

Once customer emotions are determined, a customer sentiment value is computed by translating words defining the customer emotions to numerical values in accordance with a pre-defined symbol coding scheme. An illustrative symbol coding scheme is defined by the following TABLE 1.

TABLE 1

| | |
|---|---|
| Happy | 6 |
| Surprise | 5 |
| Sad | 4 |
| Fear | 3 |
| Disgust | 2 |
| Angry | 1 |
| Neutral | 0 |

Another illustrative symbol coding scheme is defined by the following TABLE 2.

TABLE 2

| | |
|---|---|
| Happy | +1 |
| Surprise | +1 |
| Neutral | 0 |
| Sad | −1 |
| Fear | −1 |
| Disgust | −1 |
| Angry | −1 |

For example, let us assume the symbol coding scheme of TABLE 2 is employed. There are eleven customers in the RSF 150 during a given period of time. Five customers are determined to express happiness which is assigned a value of positive one. A sixth customer is determined to express surprise which is also assigned a value of positive one. A seventh customer is determined to express a neutral emotion which is assigned a value of zero. An eighth customer is determined to express sadness which is assigned a value of negative one. A ninth customer is determined to express fear which is also assigned a value of negative one. A tenth customer is determined to express disgust which is also assigned a value of negative one. An eleventh customer is determined to express anger which is also assigned a value of negative one. Customer sentiment is determined by adding the assigned values for the listed emotions together. In this case, the customer sentiment equals two (i.e., (1×5)+1+0+−1+−1+−1+−1=2). The customer sentiment value is stored in the datastore 154 as customer sentiment data 166. The present solution is not limited in this regard. The same or different positive values can be assigned to happiness and surprise, and the same or different negative values can be assigned to sadness, fear, disgust and/or anger. Also, neutral emotions can be assigned a zero value or any non-zero value.

In some scenarios, the customer sentiment values are determined using known techniques which have a margin of error that is not desirable and/or acceptable for certain applications. Accordingly, the customer sentiment values can be adjusted for improving the accuracy thereof. This adjustment may be achieved based on social media information (e.g., sentiment information obtained from social media accounts associated with certain customers), machine learned facial features/characteristics associated with certain customers, machine learned movements/actions associated with certain customers, survey results associated with certain customers, customer input, and/or inputs indicating employee perception of customer satisfaction. The listed information can be associated with the respective customers whose emotions were considered by the known technique when determining each customer sentiment value.

Other information is also used to determine the EPS. This other information includes, but is not limited to, a basket value and a transaction duration. The basket value is the total purchase price for a given transaction (in local currency). The transaction duration is the total time it takes to complete a purchase transaction. The transaction duration is defined as the time between a start time of a purchase transaction and a completion time of the purchase transaction. The start time can include, but is not limited to, the time at which a first article of a plurality of article to be purchased is scanned. The completion time can include, but is not limited to, the time at which payment has been successfully received, the time at which a customer leaves a POS station, or the time at which an employee returns from accompanying the customer to his(her) vehicle. The basket value and transaction duration are obtained from a purchase sub-system 130, and stored in a datastore 154 as transaction data 168.

The transaction data 168 is obtained during a POS process. Accordingly, a customer 110 can purchase one or more articles 106 using the POS station 102. A retail transaction application executing on a computing device 114 of the POS station 102 facilitates the exchange of data between the article(s) 106, barcode(s) 118, security tag(s) 120, customer 110, store associate 108 and/or Retail Transaction System (“RTS”) 124 of a corporate facility 152. For example, after the retail transaction application is launched, the store associate 108 is prompted to start a retail transaction process for purchasing the article(s) 106. The retail transaction process can be started simply by performing a user software interaction, such as depressing a key on a keypad of the computing device 114 or touching a button on a touch screen display of the computing device 114.

Once the retail transaction process is started, article information is provided to the POS station 102. In this regard, the user (i.e., the store associate 108 or customer 110) may manually input into the retail transaction application article information. Alternatively or additionally, the user may place a reading device 112 of the POS station 102 in proximity of article(s) 106. The reading device 112 can include, but is not limited to, an RFID reader, a Short Range Communication (“SRC”) device, and/or a barcode reader. Each of the listed devices are well known in the art, and therefore will not be described herein. Any known or to be known RFID reader, SRC device and/or barcode reader can be used herein without limitation. As a result of this placement, the POS station 102 obtains article information from the article(s) 106. The article information includes any information that is useful for purchasing the article(s) 106, such as an article identifier and an article purchase price. In some scenarios, the article information may even include security tag identifier(s). The article information can be communicated from the article(s) 106 to the reading device of the POS station 102 via a short range communication, such as a barcode communication or a Near Field Communication (“NFC”).

In the barcode scenario, article 106 has a barcode 118 attached to an exposed surface thereof. The term “barcode”, as used herein, refers to a pattern or symbol that contains embedded data. Barcodes may include, for example, one-dimensional barcodes, two dimensional barcodes (such as matrix codes, Quick Response (“QR”) codes, Aztec codes and the like), or three-dimensional bar codes. The embedded data can include, but is not limited to, a unique identifier of the article 106 and/or a purchase price of article 106. The barcode 118 is read by a barcode scanner/reader 112 of the POS station 102. Barcode scanners/readers are well known in the art. Any known or to be known barcode scanner/reader can be used herein without limitation.

In the NFC scenarios, article 106 may comprise an NFC enabled device (not shown). The NFC enabled device can be separate from security tag 120 or comprise security tag 120. An NFC communication occurs between the NFC enabled device and the handheld device (not shown) over a relatively small distance (e.g., N centimeters or N inches, where N is an integer such as twelve). The NFC communication may be established by touching components together or bringing them in close proximity such that an inductive coupling occurs between inductive circuits thereof. In some scenarios, the NFC operates at 13.56 MHz and at rates ranging from 106 kbit/s to 848 kbit/s. The NFC may be achieved using NFC transceivers configured to enable contactless communication at 13.56 MHz. NFC transceivers are well known in the art, and therefore will not be described in detail herein. Any known or to be known NFC transceivers can be used herein without limitation.

After the POS station 102 obtains the article information, operations are performed to determine if the article is accepted for purchase in accordance with known processes. If the article(s) has(have) been accepted for purchase, then payment information is input into or obtained by (e.g., via customer account information) the retail transaction application of POS station 102. In response to the reception of the payment information, the POS station 102 automatically performs operations for establishing a retail transaction session with the RTS 124. The retail transaction session can involve: communicating the article information and payment information from the POS station 102 to the RTS 124 via a public network 122 (e.g., the Internet); completing a purchase transaction by the RTS 124; and communicating a response message from the RTS 124 to the POS station 102 indicating that the article(s) 106 has(have) been successfully or unsuccessfully purchased. The purchase transaction can involve using an authorized payment system, such as a bank Automatic Clearing House (“ACH”) payment system, a credit/debit card authorization system, or a third party system (e.g., PayPal®, SolidTrust Pay® or Google Wallet®).

The purchase transaction can be completed by the RTS 124 using the article information and payment information. In this regard, such information may be received by a computing device 126 of the RTS 124 and forwarded thereby to a sub-system of a private network 128 (e.g., an Intranet). For example, the article information and purchase information can also be forwarded to and processed by a purchase sub-system 130 to complete a purchase transaction. When the purchase transaction is completed, a message is generated and sent to the POS station 102 indicating whether the article(s) 106 has(have) been successfully or unsuccessfully purchased.

If the article(s) 102 has(have) been successfully purchased, then a security tag detaching process can be started. During the security tag detaching process, a security tag detacher 116 of the POS station 102 is used to cause actuation of a detaching mechanism (e.g., a clamp inside the tag which secures a portion of a lanyard or a pin therein as known in the art) of the security tag(s) 120. Once the security tag(s) 120 has(have) been detached from article(s) 106, the customer 110 can carry the article(s) 106 through the surveillance zone without setting off the alarm.

Once the purchase transaction is completed, an EPS for the employee who handled the purchase transaction is determined based on the check-out line queue data 164, the customer sentiment data 166, and the transaction data 168 obtained immediately prior to, during and/or immediately subsequent to the purchase transaction. The EPS is defined by the following Mathematical Equation (1).

EPS=q·s·(b/t) (1)

where q represents the check-out line queue length, s represents the customer sentiment value, b represents the basket value, and t represents the transaction duration.

In some scenarios, the EPS is determined based on an average q value, an average s value, an average b value and an average t value taken over a given period of time (e.g., 1 hour). Accordingly, the EPS can also be defined by the following Mathematical Equation (2).

EPS=q_{AVG}·s_{AVG}·(b_{AVG}/_{AVG}t) (2)

where q_{AVG} represents an average check-out line queue length, s_{AVG} represents an average customer sentiment value, b_{AVG} represents an average basket value, and t_{AVG} represents an average transaction duration.

In other scenarios, the EPS is determined based on weights according to particular business characteristics, goals and/or needs. For example, some retailers might have more involved transactions that require an employee to carry purchases to vehicles. As such, these retailers might wish to apply a weighting to the transaction duration to account for the longer transaction times. Conversely, luxury retailers may have larger basket values than non-luxury retailers, and therefore may wish to apply a weighting to account for this basket value difference. Accordingly, the EPS can also be defined by the following Mathematical Equations (3)-(4).

EPS=(w₁·q)·(w₂·s)·((w₃·b)/(w₄·t) (3)

EPS=(w₁·q_{AVG})·(w₂·s_{AVG})·((w₃·b_{AVG})/(w₄·_{AVG}t)) (4)

where w₁, w₂, w₃ and w₄ represent weighting values.

In some scenarios, the EPS is calculated as a number with two decimal places. The absolute value is of less importance than the sign (negative or positive) and the trend of values over time. The calibration of the customer sentiment to the local demographics makes it difficult to compare absolute EPS values across locations. Rather, the value is in showing individual employee performance over time.

In those or other scenarios, data associated specialty or non-typical transactions that either take longer (e.g., an in-store credit card application) or have exceptionally large basket values (e.g., gift cards) is not considered when computing EPS values for employees in accordance with Mathematical Equations (2) and (4) because leaving these transactions in the averaging for EPS values could skew the results in unintended ways. EPS values determined in accordance with Mathematical Equations (1) and (3) using data associated specialty or non-typical transactions can be disregarded when determining average or cumulative EPS values for employees.

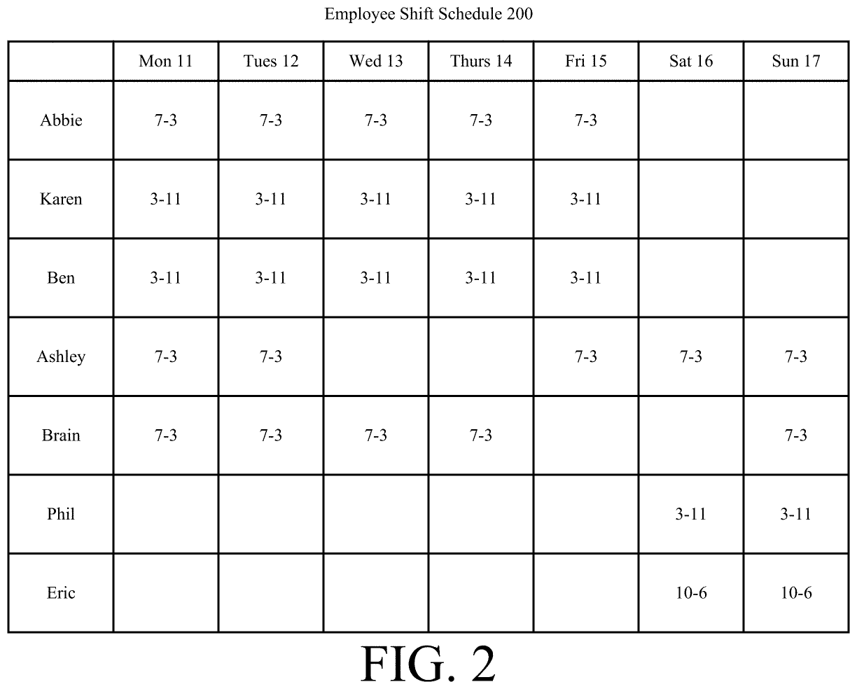

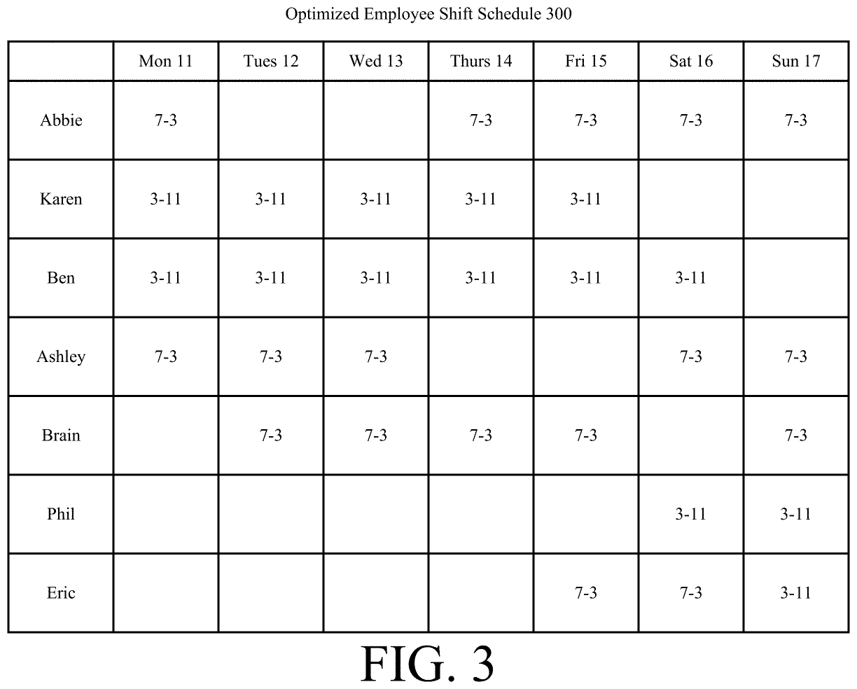

The EPS values are used to optimize employee shift schedules and/or on-shift employee floor plans. An illustrative employee shift schedule 200 is shown in FIG. 2. The employee shift schedule 200 is generated based on user inputs, for example, of a store manager. This employee shift schedule 200 may not be an optimal shift schedule. So, the EPS values for each employee are used by the system 100 (e.g., more particularly computing device 126 of FIG. 1) to analyze the employee shift schedule 200 and make recommendations for optimizing the same. For example, the EPS values for Abbie indicate that she is the most productive of all the employees (e.g., reflected by a highest EPS value for all employees), and the EPS values for Ashley indicate that she is the least productive of all employees (e.g., reflected by a lowest EPS value for all employees). It is also known that the RSF 150 experiences (1) the highest customer traffic during the first shift on Friday, Saturday and Sunday and (2) the least customer traffic during both shifts on Monday, Tuesday and Wednesday. Therefore, it is recommended that the employee shift schedule be modified such that (A) Abbie works on Friday, Saturday, Sunday, (B) Ashley works Monday, Tuesday and Wednesday, and/or (C) at least three employees work Friday, Saturday, and Sunday during the first shift. An illustrative employee shift schedule 300 is shown in FIG. 3 which has been optimized in accordance with these recommendations (A)-(C). One or more optimized employee shift schedules which have been optimized in accordance with the recommendations (A)-(C) may be presented to a user of the system. The user is then able to select one of the optimized employee shift schedules for implementation in the RSF 150. Any changes to an employee's shift schedule can be automatically communicated to him(her) via an electronic message (e.g., an email or text message) or wireless signal (e.g., an RF signal) sent to a mobile communications device (e.g., a smart phone, or radio). The present solution is not limited in this regard.

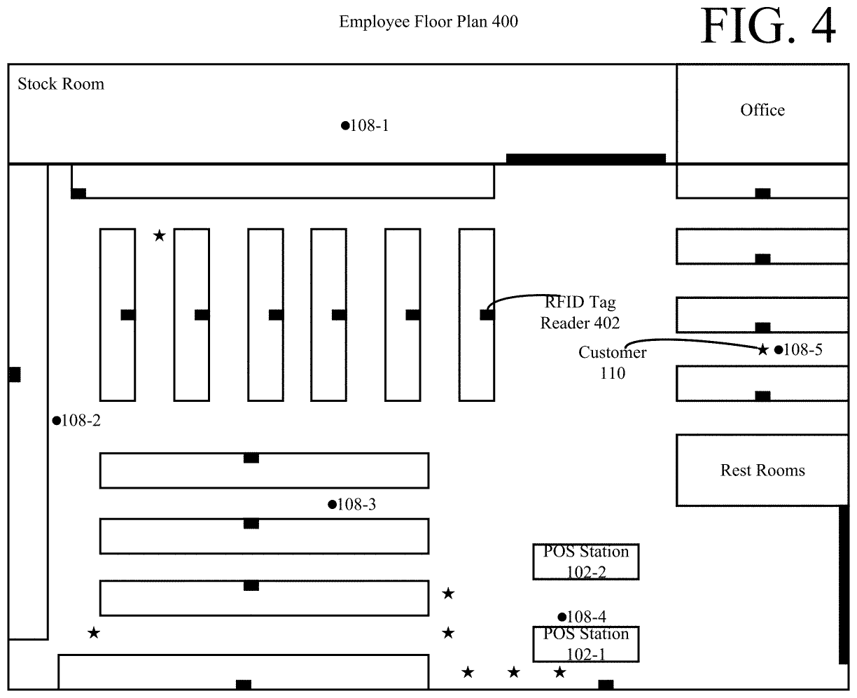

An illustrative employee floor plan 400 is shown in FIG. 4. The current locations of employees 108 and customers 110 are shown in the floor plan 400. The employee locations reflect their real time or near real time locations in the RSF 150. The employee locations can be determined in accordance with any known or to be known tracking technique. These tracking techniques include, but are not limited to, a Radio Frequency Identification (“RFID”) based tracking technique in which wearable RFID tags are detected via RFID communications, a Bluetooth based tracking technique in which wearable Bluetooth enabled devices are detected via Bluetooth communications, and/or camera based tracking techniques in which wearable tags/lanyards are detected via image processing.

In the RFID scenarios, each employee has an RFID tag 142 coupled thereto. The employees 108-1, 108-2, 108-3, 108-4, 108-5 (collectively referred to as employees 108) are identified using the unique identifiers of the RFID tags 142. As the store employee travels through the store, the RFID tags 142 are read by RFID tag readers 402 of the employee tracking system 140 of FIG. 1. RFID tags and RFID tag readers are well known in the art, and therefore will not be described herein. Any known or to be known RFID tags and/or RFID tag readers can be used herein without limitation. In contrast, as customers 110 travel through the store, images thereof are captured by the camera system 104 of FIG. 1. The images are processed by computing device 126 to detect people shown therein. The computing device 126 is able to distinguish people who are employees and people who are customers. For example, people wearing a particular uniform are considered employees, and all other people are considered customers. The present solution is not limited in this regard. Any technique for tracking and/or mapping the locations of employees and/or customers through an RSF can be used herein.

The employee floor plan 400 may not be an optimal employee floor plan at a given time. So, the EPS values for each employee are used by the system 100 (e.g., more particularly computing device 126 of FIG. 1) to analyze the employee floor plan 400 and make recommendations for employee task reassignments that will improve customer satisfaction. For example, the employee 108-4 has a relatively low EPS at least partially because of a poor customer sentiment due to the relatively long check-out line associated with the POS station 102-1 (s)he is manning. If the EPS for employee 108-4 falls below a threshold value, then a recommendation is made that an employee 108-3 (who is not currently assisting a customer) be re-assigned to man another POS station 102-2. This recommendation is presented to a store manager (e.g., via a mobile phone or other computing device), who is prompted to accept or reject the same. If the store manager accepts the recommendation, then the employee 108-3 is notified of his(her) re-assignment via an electronic message (e.g., an email or text message). The store manager can then monitor the employee floor plan 400 to confirm that the employee 108-3 acts in accordance with his(her) reassignment, i.e., travels to and begins manning the POS station 102-2. The present solution is not limited in this regard.

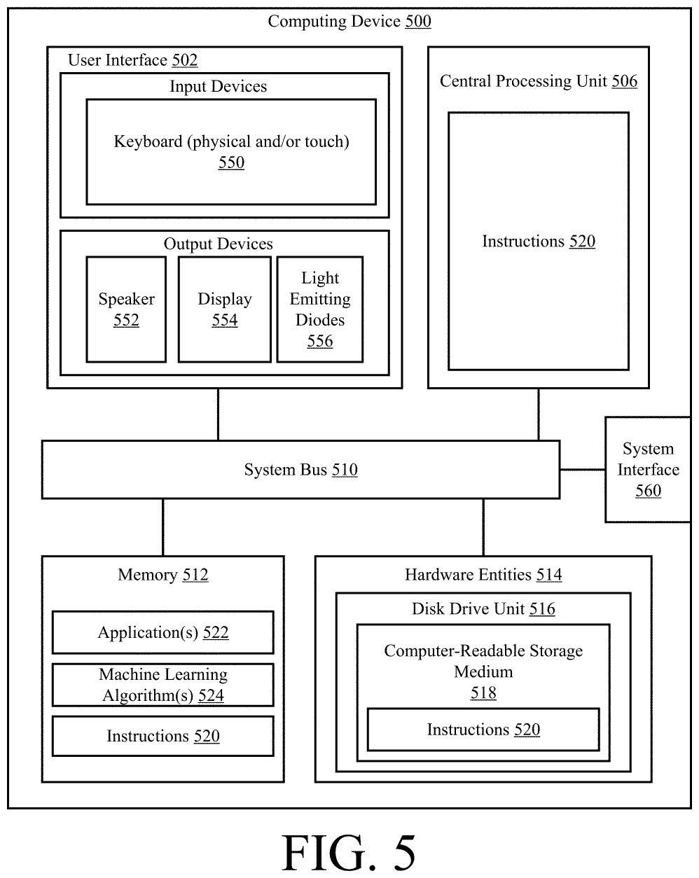

Referring now to FIG. 5, there is provided an illustration of an illustrative architecture for a computing device 500. Computing device(s) 114, 126 of FIG. 1 is(are) the same as or similar to computing device 500. As such, the discussion of computing device 500 is sufficient for understanding this component of system 100.

In some scenarios, the present solution is used in a client-server architecture. Accordingly, the computing device architecture shown in FIG. 5 is sufficient for understanding the particulars of client computing devices and servers.

Computing device 500 may include more or less components than those shown in FIG. 5. However, the components shown are sufficient to disclose an illustrative device implementing the present solution. The hardware architecture of FIG. 5 represents one implementation of a representative computing device configured to provide improved employee productivity and/or customer satisfaction, as described herein. As such, the computing device 500 of FIG. 5 implements at least a portion of the method(s) described herein.

Some or all components of the computing device 500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 5, the computing device 500 comprises a user interface 502, a Central Processing Unit (“CPU”) 506, a system bus 510, a memory 512 connected to and accessible by other portions of computing device 500 through system bus 510, a system interface 560, and hardware entities 514 connected to system bus 510. The user interface can include input devices and output devices, which facilitate user-software interactions for controlling operations of the computing device 500. The input devices include, but are not limited, a physical and/or touch keyboard 550. The input devices can be connected to the computing device 500 via a wired or wireless connection (e.g., a Bluetooth® connection). The output devices include, but are not limited to, a speaker 552, a display 554, and/or light emitting diodes 556. System interface 560 is configured to facilitate wired or wireless communications to and from external devices (e.g., network nodes such as access points, etc.).

At least some of the hardware entities 514 perform actions involving access to and use of memory 512, which can be a Random Access Memory (“RAM”), a disk driver and/or a Compact Disc Read Only Memory (“CD-ROM”). Hardware entities 514 can include a disk drive unit 516 comprising a computer-readable storage medium 518 on which is stored one or more sets of instructions 520 (e.g., software code) configured to implement one or more of the methodologies, procedures, or functions described herein. The instructions 520 can also reside, completely or at least partially, within the memory 512 and/or within the CPU 506 during execution thereof by the computing device 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 520 for execution by the computing device 500 and that cause the computing device 500 to perform any one or more of the methodologies of the present disclosure.

Computing device 500 may implement machine learning technology. In this regard, computing device 500 may run one or more software applications 522 for facilitating the machine learning of customer facial features/characteristics and/or movement/actions which are useful for determining customer sentiment. The software applications 522 performs image analysis and/or data analysis to determine EPSs for employees. The EPSs can be used for various purposes as described herein. For example, the EPSs are used to make recommendations for modification to an employee shift schedule and/or modifications to employee task assignments. The EPSs can additionally or alternatively be used to identify productive and unproductive employees, for insight into what works best for that retailer. That information can then be used (a) to train and coach employees in the model of productive employees, and/or (b) to assist with determining who should be accorded raises and/or discretionary bonuses.

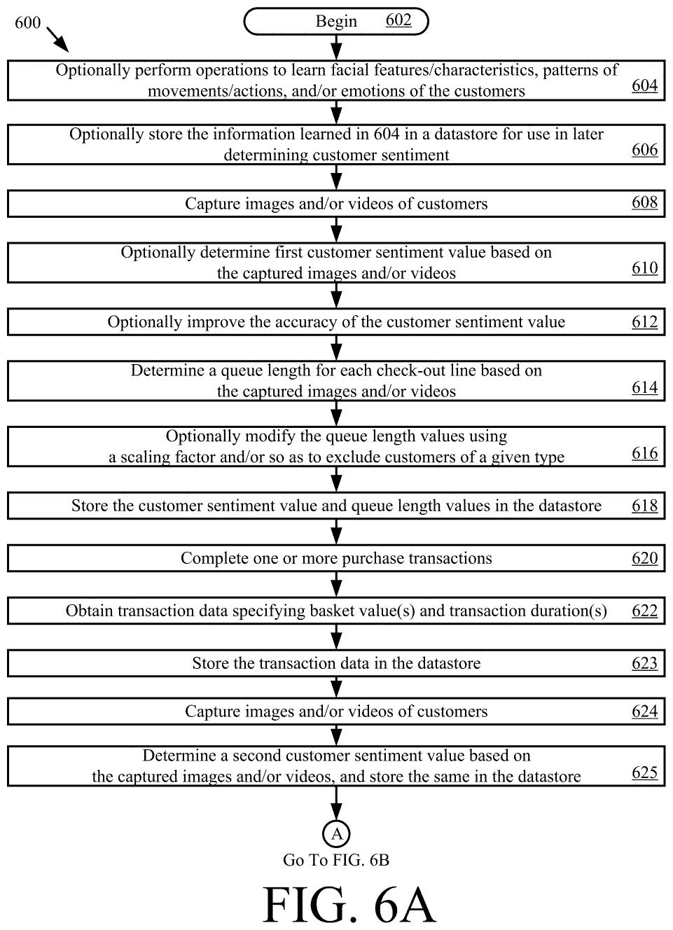

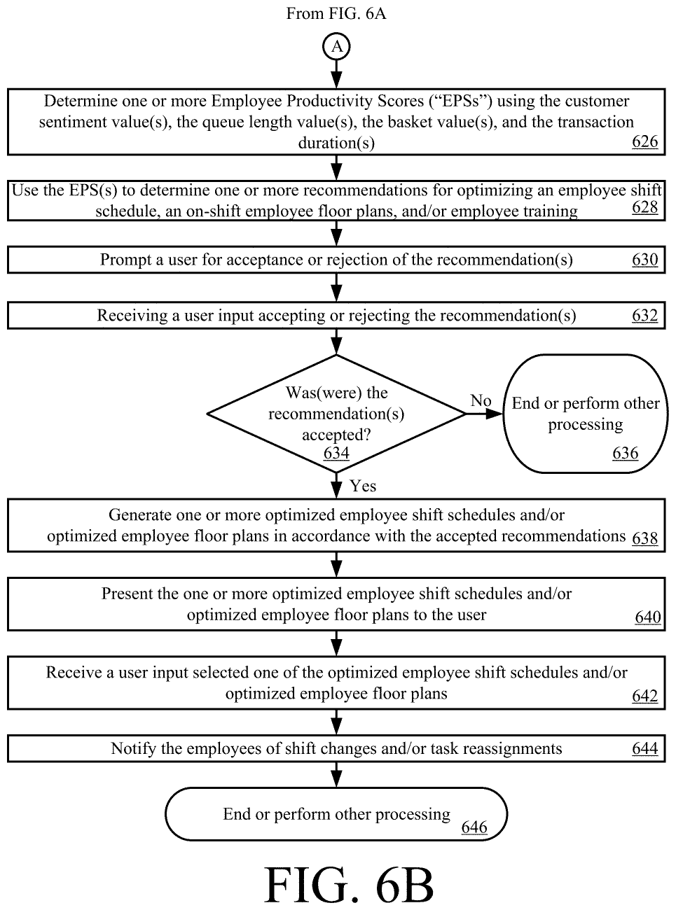

Referring now to FIG. 6, there is provided a flow diagram of an illustrative method 600 for measuring and improving employee performance. Method 600 includes a plurality of operations shown by blocks 602-646. The present solution is not limited to the order shown in FIG. 6. The operations can be performed in the same or different order than that shown in FIG. 6. For example, operations to determine one or more customer sentiment values can be performed prior to, concurrent with, and/or after a purchase transaction completion. In some scenarios, operations are performed to determine a single customer sentiment value for a given customer after completion of the purchase transaction. That way, the employee would have an opportunity to effect the customer sentiment through speed, excellent service, etc. However, in other scenarios, two customer sentiment values for the given customer are determined. A first customer sentiment value is determined before the start of a purchase transaction, and a second customer sentiment value is determined after completion of the purchase transaction. This allows one to understand how much the employee effects the customer's sentiment positively or negatively. For example, a customer could be quite upset after waiting in line for a long time, and then pleasantly satisfied by an efficient and empathetic employee processing the transaction. The present solution is not limited to the particulars of these scenarios and examples.

As shown in FIG. 6A, method 600 begins with 602 and continues with 604 where operations are optionally performed by a system (e.g., system 100 of FIG. 1) to learn facial features/characteristics, patterns of movements/actions, and/or emotions of customers (e.g., customers 110 of FIG. 1). This information can be stored in a datastore (e.g., datastore 154 of FIG. 1) for later use in determining customer sentiment, as shown by 606.

Next in 608, images and/or videos of customers are captured by a camera system (e.g., camera system 104 of FIG. 1) disposed in an RSF (e.g., RSF 150 of FIG. 1). The images and/or videos are optimally analyzed to determine a first customer sentiment value. In some scenarios, the first customer sentiment value is determined using universal facial expressions/characteristics and/or movements/actions. The customer related information learned in 604 can additionally or alternatively be used by a customer sentiment algorithm to determine customer sentiment. Customer sentiment algorithms are well known in the art, and therefore will not be described herein. Any known or to be known customer sentiment algorithm can be used herein without limitation.

The customer sentiment algorithm may have a margin of error that is not desirable or is unacceptable. As such, an accuracy of the customer sentiment value generated by the customer sentiment algorithm can optionally be improved in 612. This accuracy improvement can be achieved by adjusting the customer sentiment value based on information contained on social media sites, machine learned customer related information, survey results, customer inputs, and/or employee inputs. For example, if a person stated on a social media site (e.g., a site associated with a given customer's account or profile) that (s)he was dissatisfied with his(her) experience at the RSF, then the customer sentiment value can be decremented by a certain amount. Also, if the machine learned customer related information indicates that a particular person is typically difficult to please, then the customer sentiment value may be incremented by a certain amount. The present solution is not limited in this regard.

In 614, a queue length for each check-out line is determined based on the captured images and/or videos. The queue length can optionally be modified in 616 using a scaling factor as described above. Additionally or alternatively, the queue length is modified so that it excludes customers of a given type (e.g., children, possible thieves, and/or intoxicated individuals). The queue length and customer sentiment value are stored in the datastore, as shown by 618.

One or more purchase transactions are then performed and completed in 620. Transaction data is obtained in 622 that specifies basket value(s) and/or transaction duration(s). This transaction data is stored in the datastore, as shown by 623.

In 624-625, a second customer sentiment value is determined based on captured images and/or videos. The second customer sentiment value is also stored in the datastore. Upon completing 625, method 600 continues with 626 of FIG. 6B.

As shown in FIG. 6B, one or more EPSs are determined in 626 using the first and/or second customer sentiment values, the queue length(s), the basket value(s), and the transaction duration(s). The EPS(s) can be determined in accordance with Mathematical Equation (1), (2), (3) or (4) provided above. The EPS(s) are used in 628 to determine one or more recommendations for optimizing an employee shift schedule, an on-shift employee floor plan, and/or employee training. In 630, a user (e.g., a store manager) is prompted for acceptance or rejection of the recommendation(s). Upon completing 630, method 600 continues with 632 were at least one user input accepting or rejecting the recommendation(s) is received. A mobile device or other computing device can be used by the user to perform at least one user-software interaction for inputting a recommendation acceptance or rejection into the system (e.g., system 100 of FIG. 1).

If the recommendation(s) was(were) rejected [634:NO], then 636 is performed where method 600 ends or other processing is performed (e.g., return to 602 of FIG. 6A). In contrast, if the recommendation(s) was(were) accepted [634:YES], then method 600 continues with 638-644. 638-644 involve: generating one or more optimized employee shift schedules and/or optimized employee floor plans in accordance with the accepted recommendations; presenting the one or more optimized employee shift schedules and/or optimized employee floor plans to the user; receiving a user input selecting one of the optimized employee shift schedules and/or optimized employee floor plans; and/or automatically notifying the employees of shift changes and/or task reassignments in response to the optimized shift schedules and/or employee floor plans selection. Subsequently, 646 is performed where method 600 ends or other processing is performed.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

1.-20. (canceled)

21. A method of image detection, comprising:
capturing, by a camera, at least one image or video showing one or more customers in a facility;
performing image or video analysis to identify words that define emotions of the one or more customers shown in the at least one image or video;
translating the identified words to numerical values in accordance with a pre-defined symbol coding scheme; and
combining the numerical values to derive a customer sentiment value for the one or more customers in the at least one image or video.

22. The method according to claim 21, wherein the words are identified by comparing facial expressions and movement patterns shown in the at least one image or video to reference facial expressions and movement patterns.

23. The method according to claim 22, wherein the reference facial expressions and movement patterns are derived based on machine learned facial expressions and movement patterns of the one or more customers.

24. The method according to claim 21, further comprising improving an accuracy of the customer sentiment value based on social media information.

25. The method according to claim 21, further comprising improving an accuracy of the customer sentiment value based on machine learned customer information.

26. The method according to claim 21, further comprising improving an accuracy of the customer sentiment value based on survey results.

27. The method according to claim 21, further comprising improving an accuracy of the customer sentiment value based on customer inputs.

28. The method according to claim 21, further comprising improving an accuracy of the customer sentiment value based on employee inputs.

29. The method according to claim 21, further comprising improving an accuracy of the customer sentiment value based on two or more of social media information, machine learned customer information, survey results, customer inputs, or employee inputs.

30. A computing device, comprising:
a memory;
a processor in communication with the memory and configured to:
receive, from a camera, at least one image or video showing one or more customers in a facility;
perform image or video analysis to identify words that define emotions of the one or more customers shown in the at least one image or video;
translate the identified words to numerical values in accordance with a pre-defined symbol coding scheme; and
combine the numerical values to derive a customer sentiment value for the one or more customers in the at least one image or video.

31. The computing device according to claim 30, wherein the words are identified by comparing facial expressions and movement patterns shown in the at least one image or video to reference facial expressions and movement patterns.

32. The computing device according to claim 31, wherein the reference facial expressions and movement patterns are derived based on machine learned facial expressions and movement patterns of the one or more customers.

33. The computing device according to claim 30, further comprising improving an accuracy of the customer sentiment value based on social media information.

34. The computing device according to claim 30, further comprising improving an accuracy of the customer sentiment value based on machine learned customer information.

35. The computing device according to claim 30, further comprising improving an accuracy of the customer sentiment value based on survey results.

36. The computing device according to claim 30, further comprising improving an accuracy of the customer sentiment value based on customer inputs.

37. The computing device according to claim 30, further comprising improving an accuracy of the customer sentiment value based on employee inputs.

38. The computing device according to claim 30, further comprising improving an accuracy of the customer sentiment value based on two or more of social media information, machine learned customer information, survey results, customer inputs, or employee inputs.

39. A non-transitory computer-readable storage medium comprising programming instructions executable by a processor to implement the method of claim 1.
